(19) United States
(12) Patent Application Publication
(10) Pub. No.: US 2023/0300157 A1
(43) Pub. Date: Sep. 21, 2023

(54) METHOD AND SYSTEM FOR MONITORING NETWORK ACTIVITY

(71) Applicant: NAGRAVISION SARL, CHESEAUX-SUR-LAUSANNE (CH)

(72) Inventors: Joshua Roys, Atlanta, GA (US); William Lane, Atlanta, GA (US)

(73) Assignee: NAGRAVISION SARL, CHESEAUX-SUR-LAUSANNE (CH)

(21) Appl. No.: 17/697,191

(22) Filed: Mar. 17, 2022

(51) Int. Cl. H04L 9/40

(52) U.S. Cl. CPC H04L 63/1425

(57) ABSTRACT

Systems and techniques are described herein for monitoring network activity between a customer premise and the Internet, identifying data packets for review that are exchanged between the customer premise and the Internet, determining Internet Protocol address information for the data packets, receiving device name information associated with the data packets, and sending information to the customer premise that includes the device name and alert information related to the data packets.

### FIELD

The present disclosure generally relates to monitoring data traffic at an internet service provider to identify a particular customer device that may be associated with suspicious activity, where the data traffic is sent between a customer premise and the Internet. This includes obtaining information from a router at the customer premise to help identify the customer device associated with the suspicious activity.

### BACKGROUND

Internet Service Providers (ISPs) connect a wide range of customers to the Internet. Some of those customers are small and medium size businesses, and those customers may benefit from cybersecurity services. Some approaches for providing those cybersecurity services include client-side solutions with firewalls, and/or router firmware/agents. However, deploying those types of services may not be appropriate for the ISP and/or customer. Monitoring network traffic at the ISP using protocols like netflow may require capital-intensive collector appliances deployed at the customer premise. Although a netflow solution can generate massive amounts of flow data, this is generally captured post-NAT, and therefore it is still unable to identify a specific client device on the customer network that may be infected or compromised. The methods and systems described herein address some of those issues.

### SUMMARY

Techniques and systems are described herein for monitoring network activity and identifying a customer device that may be associated with suspicious Internet activities.

According to at least one example, a method is provided for monitoring network activity. The method includes: monitoring a plurality of data packets exchanged between a local network and an external network; identifying, from the plurality of data packets, at least one data packet for review; determining Internet Protocol (IP) address information associated with the at least one data packet; receiving first information from a first device connected to the local network, the first information including at least a device name associated with the IP address information; and generating and sending second information that includes at least the device name and alert information related to the at least one data packet.

In another example, a system for monitoring network activity is provided that includes a storage configured to store instructions and at least one processor configured to execute the instructions and cause the at least one processor to: monitor a plurality of data packets exchanged between a local network and an external network; identify, from the plurality of data packets, at least one data packet for review; determine Internet Protocol (IP) address information associated with the at least one data packet; receive first information from a first device connected to the local network, the first information including at least a device name associated with the IP address information; and generate and send second information that includes at least the device name and alert information related to the at least one data packet.

In another example, a non-transitory computer-readable medium is provided that has stored thereon instructions that, when executed by one or more processors, cause the one or more processors to: monitor a plurality of data packets exchanged between a local network and an external network; identify, from the plurality of data packets, at least one data packet for review; determine Internet Protocol (IP) address information associated with the at least one data packet; receive first information from a first device connected to the local network, the first information including at least a device name associated with the IP address information; and generate and send second information that includes at least the device name and alert information related to the at least one data packet.

In another example, an apparatus for monitoring network activity is provided. The apparatus includes: means for monitoring a plurality of data packets exchanged between a local network and an external network; means for identifying, from the plurality of data packets, at least one data packet for review; means for determining Internet Protocol (IP) address information associated with the at least one data packet; means for receiving first information from a first device connected to the local network, the first information including at least a device name associated with the IP address information; and means for generating and sending second information that includes at least the device name and alert information related to the at least one data packet.

In some aspects, the method, apparatuses, and computer-readable medium described above can include identifying the at least one data packet for review based on threat information.

In some aspects, the method, apparatuses, and computer-readable medium described above can include receiving the first information according to the Device Data Model for TR-069.

In some aspects, the method, apparatuses, and computer-readable medium described above can include using the Customer Provided Equipment (CPE) Wide Area Network (WAN) management protocol to receive the first information.

In some aspects, the method, apparatuses, and computer-readable medium described above can include sending at least some of the second information to an electronic mail address associated with the local network.

In some aspects, the method, apparatuses, and computer-readable medium described above can include posting at least some of the second information to a customer portal associated with the local network.

In some aspects, the method, apparatuses, and computer-readable medium described above can include monitoring data exchanged between a plurality of local networks and the external network; and identifying threat information based on the monitored data.

In some aspects of the method, apparatuses, and computer-readable medium described above, the external network is the Internet.

In some aspects of the method, apparatuses, and computer-readable medium described above, the alert information related to the at least one data packet includes threat information.

In some aspects of the method, apparatuses, and computer-readable medium described above, the first information further includes media access control (MAC) address information.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example system for monitoring network activity, in accordance with some examples;

FIG. 2 is a block diagram illustrating an example system for monitoring network activity, in accordance with some examples;

FIG. 3 is a block diagram illustrating an example of a server device, in accordance with some examples; and

FIG. 4 is a flow diagram illustrating an example of a process for monitoring network activity and performing one or more functions based on monitoring network activity, in accordance with some examples;

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

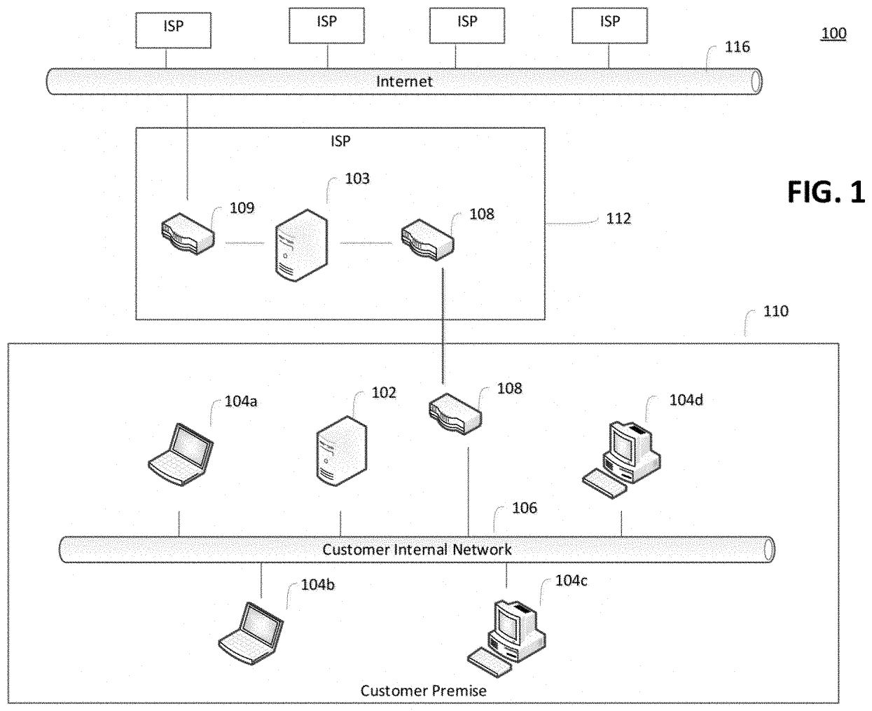

Referring to FIG. 1, system 100 includes at least an internet service provider (ISP) 112, which is connected to a customer premise 110. The connection between ISP 112 and customer premise 110 might be wireless, or it might be a physical connection that uses coaxial cable, fiber optic cable, or twisted pair telephone line. The form of connection between ISP 112 and customer premise 110 is not particularly important.

Customer premise 110 might be a business, or it might be a residence. In general, customer premise 110 includes more than one connected device, such as server 102, and one or more user client devices 104. Server 102 and user client devices 104 are electronically connected, such as through local network 106. Network 106 might be a physical network made of cable, such as ethernet, and/or it might be a wireless network such as WiFi. Access to network 106 for individual user client devices 104 typically occurs through a hardwire ethernet connection, or through a wireless access point. The connection between ISP 112 and customer premise 110 is typically through a router 108 at each location. To ensure interoperability between different brands of equipment, routers 108 generally conform to established standards. TR-069 and TR-181, which are managed and maintained by The Broadband Forum, are examples of these established standards.

ISP 112 provides customer premise 110 with a connection to the Internet 116. That connection to the Internet allows customer premise 110 to send and receive information according to established Internet standards. In general, unless an end-user is very large and sophisticated, they will use the services of an ISP to provide and maintain a connection to the Internet 116. Examples of ISPs connected to the Internet 116 are illustrated in FIG. 1. A connection between ISP 112 and the Internet 116 requires the use of specific protocols. As illustrated, router 109 provides that connection, and because it must conform to those specific Internet protocols, it may be different from router 108, which connects to customer premise 110.

To manage and maintain the various functions required by ISP 112, one or more servers 103 are connected to routers 108 and 109. Many of the features described herein are performed by server 103.

ISP 112 is in a unique position, positioned between customer premise 110 and the Internet 116. In that position, all traffic that customer premise 110 sends to the Internet 116, or receives from the Internet 116 will pass through ISP 112. Virtually all of that traffic is contained in data packets that are formatted according to one or more standards. The data packets themselves include Internet Protocol (IP) address information that identifies the data packet sender, and the intended recipient of the data packet. Even when some of the data contained within the data packets is encrypted, the address information is exposed so the data packets can be properly routed as they travel through various routers, switches, and connections from the source to the destination.

Sadly, bad actors can exploit vulnerabilities in a customer premise 110 using the Internet. Computer viruses, ransom ware, denial of service attacks and other bad acts mean that monitoring traffic between customer premise 110 and the Internet 116 is important. This monitoring can be performed from within the customer premise 110, in which case a network administrator will generally have nearly full access to all traffic on customer local network 106, as well as all traffic that passes to and from the Internet 116 through router 108. This can allow the network administrator to identify malicious activity. In addition, because the monitoring is being done by a network administrator or trusted entity connected to customer premise 110, that administrator has access to internal router tables, and device identification, and can generally determine which particular device might be compromised.

Good network administrators are in short supply, and a small or medium size company may not have such an individual. By contrast ISP 112 will almost certainly have qualified network administrators. But, a network administrator working at ISP 112 will generally have no access, or only minimal access to the internal workings of customer premise 110. What ISP 112 has access to is the traffic passing between the Internet 116 and many different customer premises 110. By monitoring the traffic through the ISP, it is often possible to determine that there is some suspicious or known malicious action occurring. This could be the exchange of data packets with a known malicious IP address. It could also be unusual higher activity levels at certain times of the day, when the history has shown minimal traffic. It could also be an increase in levels of activity to/from one particular IP address that is attached to customer premise 110.

It is possible for ISP 112 to alert the customer of that suspicious activity, and it becomes the responsibility of the customer to determine which particular device may have been compromised. For smaller size companies without a dedicated network administrator, this may not help much, because tracking down a suspect device associated with that IP address may require logging into router 108 and then accessing the router tables, or accessing other information.

The features described herein allow ISP 112 to include additional information identifying the device that may have been compromised along with the alert of suspicious activity.

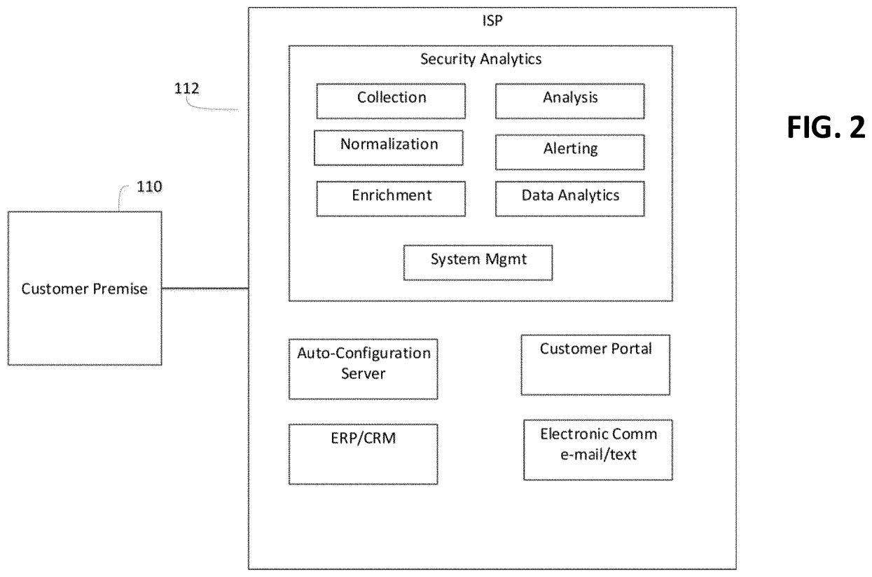

Referring to FIG. 2, features of ISP 112 and customer premise 110 are illustrated in block form. Some of the features of ISP 112 include a security analytics platform, an auto-configuration server, Enterprise Resource Planning (ERP)/Customer Relationship Management (CRM), a customer portal, and electronic communications, such as e-mail and/or text messaging.

The components of the security analytics platform collect information from customer premise 110. This collection might be periodic, such as every 15 seconds, or it might be event driven, such as following identification of suspicious activity. The collected information from customer premise 110 might include known hosts, source and destination IP addresses, ports and protocols. This collected information can be accessed by server 103 from customer premise 110 using network management mechanisms, such as the auto-configuration server.

As previously mentioned, the Broadband Forum manages and maintains standards, and TR-069 (also known as Customer Premise Equipment WAN Management Protocol (CWMP)) is one of those standards. TR-069 describes an Internet protocol that is based on XML/SOAP, and in certain aspects it enables remote configuration of network devices. If router 108 at customer premise 110 complies with the TR-069 standard, then it is an example of a network device that can be remotely configured. The remote configuration of router 108 at customer premise 110 can thus be performed by ISP 112.

Specifically, the device data model for TR-069, which is described in TR-181 Issue 2 Amendment 14, recites use cases, with a particular use case being:

### IV.5 Provide Extended Home Networking Topology View

Another use case is to determine the topology of the home network behind the gateway. For a generic understanding of the network, the Host table provides information such as the layer 2 and layer 3 interfaces via which the Host is connected as well as DHCP lease information for each connected Host.
If the operator is interested in UPnP devices in the home network, the UPnP.Discovery tables (RootDevice, Device, and Service) provide that information in addition to the Host table entries that correspond to a particular UPnP Root Device, Device, or Service.
Finally for CWMP enabled CPEs, the ManageableDevice table within the ManagementServer object provides information about the CWMP managed devices that the CPE has learned about through the DHCP message exchange defined in TR-069 [2] Annex F.

The Host table mentioned above is further described in TR-181-2-2-0, an example of which is available at: https://cwmp-data-models.broadband-forum.org/tr-181-2-2-0.html. For devices that use IPV4, the field “Device.Hosts.Host[x].IPv4Address[y].IPAddress” can be retrieved by the auto-configuration server of ISP 112 from router 108 at customer premise 110. The corresponding field would be “Device.Hosts.Host[x].IPv6Address[y].IPAddress” for IPV6.

This is an extract with descriptions of those fields:

| | | |
|---|---|---|
| Device.Hosts.Host.{i}.IPv4Address.{i}. | object | The host's known IPv4 addresses. This |
| | | includes any addresses assigned via |
| | | DHCP, which can also be accessed via |
| | | the DHCPClient reference. |
| | | At most one entry in this table can exist |
| | | with a given value for IPAddress. |
| IPAddress | string(15) | [IPv4Address] IPv4 address. |
| Device.Hosts.Host.{i}.IPv6Address.{i}. | object | The host's known IPv6 addresses. This |
| | | includes any addresses assigned via |
| | | DHCP, which can also be accessed via |
| | | the DHCPClient reference. |
| | | At most one entry in this table can exist |
| | | with a given value for IPAddress. |
| IPAddress | string(45) | [IPv6Address] IPv6 address. |
| Device.Hosts. | object | This object provides information about |
| | | each of the hosts on the LAN, including |
| | | those whose IP address was allocated |
| | | by the CPE using DHCP as well as hosts |
| | | with statically allocated IP addresses. It |
| | | can also include non-IP hosts. |
| Device.Hosts.Host.{i}. | object | Host table. |
| | | At most one entry in this table can exist |
| | | with a given value for Alias, or with a |
| | | given value for PhysAddress. |
| Alias | string(64) | A non-volatile handle used to reference |
| | | this instance. Alias provides a |
| | | mechanism for an ACS to label this |
| | | instance for future reference. An initial |
| | | unique value MUST be assigned when |
| | | the CPE creates an instance of this |
| | | object. |
| PhysAddress | string(64) | Unique physical identifier of the host. |
| | | For many layer 2 technologies this is |
| | | typically a MAC address. |
| HostName | string(64) | The device's host name or an empty |
| | | string if unknown. |

ISP 112 is able to collect this information on a periodic basis, such as when an unknown internal IP is found in the PortMapping table, or some other trigger event. Thus, for all Host[s] entries, retrieve PhysAddreess (MAC address) and HostName parameters to help identify the particular device. The MAC address can uniquely identify a network interface device that is generally installed in a particular device and providing a wired or wireless connection to router 108 within the customer premise. The HostName may include a name that has been assigned to a particular device, such as “J_Smith_Laptop.” Because a MAC address is unique, it is possible to identify the associated device (computer, phone etc.). However, the MAC address is simply a number, such as 60-F2-62-EC-45-41, and doesn't readily translate to an identifiable device that is connected to router 108. Given a MAC address, a small business owner can eventually determine the associated device. Where the HostName is included, and it has a plain text description to identify a particular device (such as “J_Smith_Laptop”), that HostName may be more helpful information to the small business owner than the MAC address as they search for the specific device that might be compromised.

In addition, for all IPv4Address[y] or IPv6Address[y], retrieve the IPAddress. The retrieved data is checked to ensure it is valid. If valid, then normalize the data, such as use of conventional string format, with no extra zeros or spaces, zero-pad to ensure all IPs are 15 (IPv4) or 45 (IPv6) characters long, and then convert to some standard format, such as binary 4-byte format. By normalizing the data, different formats from different systems can be put into a common format.

Similar to the MAC address, a customer can use the IPAddress information to identify a particular device, but the IPAddress can change over time. Thus, if the HostName is available, it may be more helpful.

The discussion above with reference to TR-069 refers to Device.Hosts information. That Device.Hosts information is important, but separate from the NAT tables. The NAT tables can be used to translate an “outside” IP address/port/protocol back to an “inside” IP address which is then used with the Device.Hosts table to identify the device by name or MAC.

ISP 112 is able to provide alerts to the customer, such as indications a host is communicating with a known command and control (C&C) server, crypto mining operations, etc. An alert can also be provided when it appears a host is participating in a distributed denial-of-service (DDoS) attack. All of these might be considered threats, and appropriate for alerts to the customer. The alert can include any or all of the information that is retrieved, such as details on the specific threat, the IPAddress, the HostName, the MAC Address etc.

The alert information might be specific to the customer premise, or it might include generic information that is not specific to a particular customer premise.

Alerts from ISP 112 to the customer could be in the form of an e-mail or text message. The alerts might also be posted or provided through the customer portal.

ISP 112 is also able to monitor the connections of other customer premises that are serviced, and in this way ISP 112 can identify threats that are occurring on one customer system, and use that identified threat information as it monitors the other customer connections to other systems.

Various use case examples will now be described using the systems and techniques described herein.

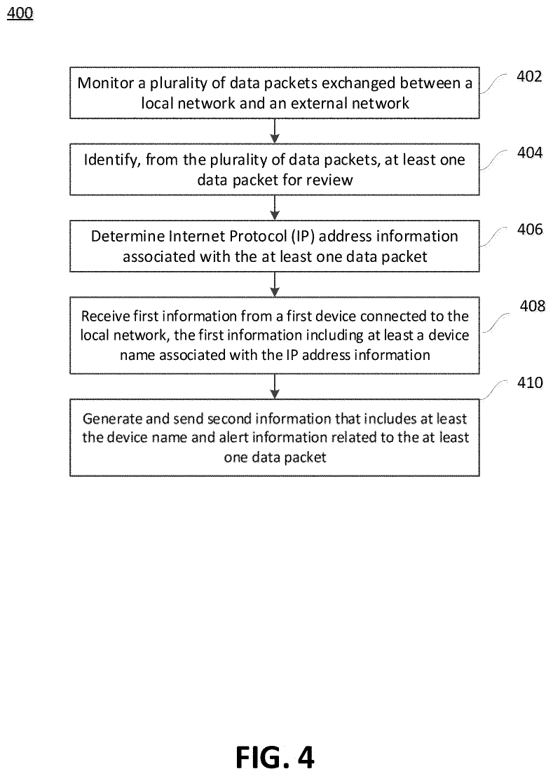

FIG. 4 is a flow diagram illustrating an example of a process 400 for monitoring network activity, and performing one or more functions based on the monitored activity. At block 402, the process 400 includes monitoring, at server 103, a plurality of data packets that are exchanged between a local network (106) and an external network (116.) The data packets generally confirm to Internet Protocols (IP), where they include IP address information of sender and intended recipient, as well as payload.

At block 404, the process 400 includes identifying, at server 103, and from the plurality of monitored data packets, at least one data packet for review. The at least one data packet may be selected for review because it appears to be associated with some form of threat or compromise. The compromise or threat might be associated with a computer virus, a ransom ware attack, a denial of service attack, or any other form of malicious activity.

At block 406, the process 400 includes determining internet protocol (IP) address information associated with the at least one data packet. The IP Address information included in the data packet header may be used for this.

At block 408, the process 400 includes receiving first information from a first device connected to the local network, where that first information includes at least a device name associated with the IP Address information. As described above, this may include extracting information from the Host table that includes MAC Address, Alias, PhysAddress and/or NostName information.

At block 410, the process 400 includes generating and sending second information from server 103 that includes at least the device name, and alert information related to the at least one data packet. The device name might be the MAC Address, Alias, PhysAddress or the HostName information. The alert information might expand on the suspicious activity or possible compromise, such as a computer virus, a ransom ware attack, or a denial of service attack.

In some examples, the external network in process 400 is the Internet. In other examples, the alert information related to the at least one data packet includes threat information. In other examples, the first information includes media access control (MAC) address information. The process 400 can further include identifying the at least one data packet for review based on threat information. The process 400 can further include receiving the first information according to the Device Data Model for TR-069. The process 400 can further include using the Customer Provided Equipment (CPE) Wide Area Network (WAN) management protocol to receive the first information. The process 400 can further include sending at least some of the second information to an electronic mail address associated with the local network. The process 400 can further include posting at least some of the second information to a customer portal associated with the local network. The process 400 can further include monitoring data exchanged between a plurality of local networks and the external network; and identifying threat information based on the monitored data.

The components of the devices and/or servers configured to perform the processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes may be described or illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (as illustrated in FIG. 4) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

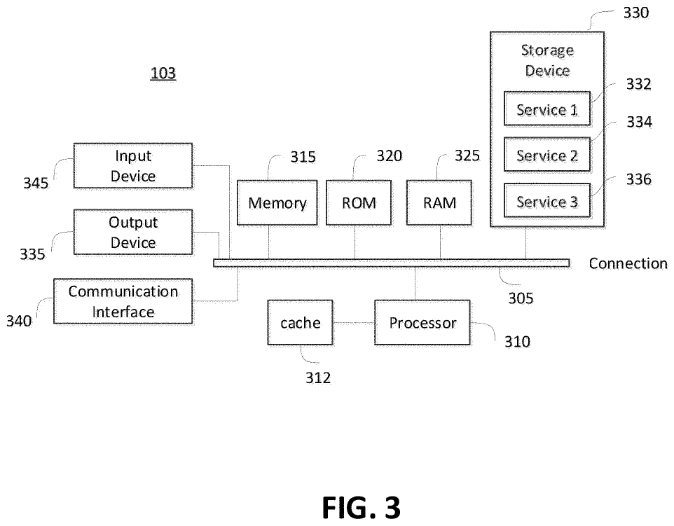

FIG. 3 is a diagram illustrating an example of a system for implementing certain aspects of the techniques described herein. In particular, FIG. 3 illustrates an example of ISP 112 server 103, which can be, for example, any computing device making up internal computing system, a remote computing system, another computing device or system, or any component thereof in which the components of the system are in communication with each other using connection 305. Connection 305 can be a physical connection using a bus, or a direct connection into processor 310, such as in a chipset architecture. Connection 305 can also be a virtual connection, networked connection, or logical connection.

In some embodiments, server 103 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example server 103 includes at least one processing unit (CPU or processor) 310 and connection 305 that couples various system components including system memory 315, such as read-only memory (ROM) 320 and random access memory (RAM) 325 to processor 310. Server 103 can include a cache 312 of high-speed memory connected directly with, in close proximity to, or integrated as part of processor 310.

Processor 310 can include any general purpose processor and a hardware service or software service, such as services 332, 334, and 336 stored in storage device 330, configured to control processor 310 as well as a special-purpose processor where software instructions are incorporated into the actual processor design. Processor 310 may essentially be a completely self-contained computing system, containing multiple cores or processors, a bus, memory controller, cache, etc. A multi-core processor may be symmetric or asymmetric.

To enable user interaction, server 103 includes an input device 345, which can represent any number of input mechanisms, such as a microphone for speech, a touch-sensitive screen for gesture or graphical input, keyboard, mouse, motion input, speech, etc. Server 103 can also include output device 335, which can be one or more of a number of output mechanisms, including speakers. In some instances, multimodal systems can enable a user to provide multiple types of input/output to communicate with server 103. Server 103 can include communications interface 340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 340 may also include one or more Global Navigation Satellite System (GNSS) receivers or transceivers that are used to determine a location of server 103 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 330 can include software services, servers, services, etc., that when the code that defines such software is executed by the processor 310, it causes the system to perform a function. In some embodiments, a hardware service that performs a particular function can include the software component stored in a computer-readable medium in connection with the necessary hardware components, such as processor 310, connection 305, output device 335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Services 332, 334, 336 may include one or more of the security analytics platform, the auto-configuration server, the customer portal, the ERP/CRM, and the electronic communication e-mail/text illustrated in FIG. 2.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: A method of monitoring network activity, the method comprising: monitoring a plurality of data packets exchanged between a local network and an external network; identifying, from the plurality of data packets, at least one data packet for review; determining Internet Protocol (IP) address information associated with the at least one data packet; receiving first information from a first device connected to the local network, the first information including at least a device name associated with the IP address information; and generating and sending second information that includes at least the device name and alert information related to the at least one data packet.

Aspect 2: The method according to Aspect 1, wherein the external network is the Internet.

Aspect 3: The method according to any of Aspects 1 to 2, further comprising: identifying the at least one data packet for review based on threat information.

Aspect 4: The method according to any of Aspects 1 to 3, further comprising: receiving the first information according to the Device Data Model for TR-069.

Aspect 5: The method according to any of Aspects 1 to 4, further comprising: using the Customer Provided Equipment (CPE) Wide Area Network (WAN) management protocol to receive the first information.

Aspect 6: The method according to any of Aspects 1 to 5, wherein the alert information related to the at least one data packet includes threat information.

Aspect 7: The method according to any of Aspects 1 to 6, further comprising: sending at least some of the second information to an electronic mail address associated with the local network.

Aspect 8: The method according to any of Aspects 1 to 7, further comprising: posting at least some of the second information to a customer portal associated with the local network.

Aspect 9: The method according to any of Aspects 1 to 8, wherein the first information further includes media access control (MAC) address information.

Aspect 10: The method according to any of Aspects 1 to 9, further comprising: monitoring data exchanged between a plurality of local networks and the external network; and identifying threat information based on the monitored data.

Aspect 11: A system for monitoring network activity, the system comprising: a storage configured to store instructions; and at least one processor configured to execute the instructions and cause the at least one processor to: monitor a plurality of data packets exchanged between a local network and an external network; identify, from the plurality of data packets, at least one data packet for review; determine Internet Protocol (IP) address information associated with the at least one data packet; receive first information from a first device connected to the local network, the first information including at least a device name associated with the IP address information; and generate and send second information that includes at least the device name and alert information related to the at least one data packet.

Aspect 12: The system according to Aspect 11, wherein the external network is the Internet.

Aspect 13: The system according to any of Aspects 11 to 12, wherein the at least one processor is further configured to execute the instructions and cause the at least one processor to: identify the at least one data packet for review based on threat information.

Aspect 14: The system according to any of Aspects 11 to 13, wherein the at least one processor is further configured to execute the instructions and cause the at least one processor to: receive the first information according to the Device Data Model for TR-069.

Aspect 15: The system according to any of Aspects 11 to 14, wherein the at least one processor is further configured to execute the instructions and cause the at least one processor to: use the Customer Provided Equipment (CPE) Wide Area Network (WAN) management protocol to receive the first information.

Aspect 16: The system according to any of Aspects 11 to 15, wherein the alert information related to the at least one data packet includes threat information.

Aspect 17: The system according to any of Aspects 11 to 16, wherein the at least one processor is further configured to execute the instructions and cause the at least one processor to: send at least some of the second information to an electronic mail address associated with the local network.

Aspect 18: The system according to any of Aspects 11 to 17, wherein the at least one processor is further configured to execute the instructions and cause the at least one processor to: post at least some of the second information to a customer portal associated with the local network.

Aspect 19: The system according to any of Aspects 11 to 18, wherein the first information further includes media access control (MAC) address information.

Aspect 20: The system according to any of Aspects 11 to 19, wherein the at least one processor is further configured to execute the instructions and cause the at least one processor to: monitor data exchanged between a plurality of local networks and the external network; and identify threat information based on the monitored data.

Aspect 21: A non-transitory computer-readable medium is provided that has stored thereon instructions that, when executed by one or more processors, cause the one or more processors to perform operations according to any of Aspects 1 to 20.

Aspect 22: An apparatus for monitoring network activity is provided, comprising one or more means for performing operations according to any of Aspects 1 to 20.

What is claimed is:

1. A method of monitoring network activity, the method comprising:
monitoring a plurality of data packets exchanged between a local network and an external network;
identifying, from the plurality of data packets, at least one data packet for review;
determining Internet Protocol (IP) address information associated with the at least one data packet;
receiving first information from a first device connected to the local network, the first information including at least a device name associated with the IP address information; and
generating and sending second information that includes at least the device name and alert information related to the at least one data packet.

2. The method according to claim 1, wherein the external network is the Internet.

3. The method according to claim 1, further comprising identifying the at least one data packet for review based on threat information.

4. The method according to claim 1, further comprising receiving the first information according to the Device Data Model for TR-069.

5. The method according to claim 1, further comprising using the Customer Provided Equipment (CPE) Wide Area Network (WAN) management protocol to receive the first information.

6. The method according to claim 1, wherein the alert information related to the at least one data packet includes threat information.

7. The method according to claim 1, further comprising sending at least some of the second information to an electronic mail address associated with the local network.

8. The method according to claim 1, further comprising posting at least some of the second information to a customer portal associated with the local network.

9. The method according to claim 1, wherein the first information further includes media access control (MAC) address information.

10. The method according to claim 1, further comprising:
monitoring data exchanged between a plurality of local networks and the external network; and
identifying threat information based on the monitored data.

11. A system for monitoring network activity, the system comprising:
a storage configured to store instructions; and
at least one processor configured to execute the instructions and cause the at least one processor to:
monitor a plurality of data packets exchanged between a local network and an external network;
identify, from the plurality of data packets, at least one data packet for review;
determine Internet Protocol (IP) address information associated with the at least one data packet;
receive first information from a first device connected to the local network, the first information including at least a device name associated with the IP address information; and
generate and send second information that includes at least the device name and alert information related to the at least one data packet.

12. The system according to claim 11, wherein the external network is the Internet.

13. The system according to claim 11, wherein the at least one processor is further configured to execute the instructions and cause the at least one processor to identify the at least one data packet for review based on threat information.

14. The system according to claim 11, wherein the at least one processor is further configured to execute the instructions and cause the at least one processor to receive the first information according to the Device Data Model for TR-069.

15. The system according to claim 11, wherein the at least one processor is further configured to execute the instructions and cause the at least one processor to use the Customer Provided Equipment (CPE) Wide Area Network (WAN) management protocol to receive the first information.

16. The system according to claim 11, wherein the alert information related to the at least one data packet includes threat information.

17. The system according to claim 11, wherein the at least one processor is further configured to execute the instructions and cause the at least one processor to send at least some of the second information to an electronic mail address associated with the local network.

18. The system according to claim 11, wherein the at least one processor is further configured to execute the instructions and cause the at least one processor to post at least some of the second information to a customer portal associated with the local network.

19. The system according to claim 11, wherein the first information further includes media access control (MAC) address information.

20. The system according to claim 11, wherein the at least one processor is further configured to execute the instructions and cause the at least one processor to:
monitor data exchanged between a plurality of local networks and the external network; and
identify threat information based on the monitored data.
